(19) United States
(12) Patent Application Publication
(10) Pub. No.: US 2025/0010814 A1
(43) Pub. Date: Jan. 9, 2025

(54) KEY FOR A VEHICLE

(71) Applicant: KEYLINE S.P.A., Conegliano (TV) (IT)

(72) Inventors: Massimo Bianchi, Cappella Maggiore (TV) (IT); Luca Baratti, Pianzano (TV) (IT)

(21) Appl. No.: 18/695,122

(22) PCT Filed: Sep. 19, 2022
(86) PCT No.: PCT/IB2022/058820

§ 371 Date: Mar. 25, 2024

(30) Foreign Application Priority Data
Sep. 23, 2021 (IT) 102021000024508

(51) Int. Cl. B60R 25/24; E05F 15/00

(52) U.S. Cl. CPC B60R 25/241; E05F 15/00

(57) ABSTRACT

The invention refers to a key for a vehicle. The key for a vehicle comprises a control unit and a. first wireless communication module operatively connected to said control unit and adapted to allow said control unit to communicate with a control system of said vehicle. The key for a vehicle comprises user interface means operatively connected to said control unit and which can be manually operated by a user to interact with the control system of said vehicle, by means of the control unit. The above-mentioned user interface means can be operated manually to transmit a user identification code to said control unit. Said control unit is configured to transmit the identification code received from said user interface means to the control system of said vehicle, via said first wireless communication module.

The present invention refers to a key for a vehicle particularly suitable for use in vehicles intended for mixed use, for example in vehicles for care hire or car sharing services, company fleets, and the like.

As is known, today computerised systems are available for entry to a mixed use vehicle in keyless mode. Examples of said technical solutions are described in the patent documents U.S. Pat. No. 9,460,577B2, US2019/0110199A1 and US2016/0019738A1.

In general, in the computerised systems of this type the user receives an identification code (typically called electronic key) on his/her mobile computerised device (for example a smartphone) and transmits said identification code to an electronic device installed on board the vehicle. Said electronic device interacts with the vehicle control system for recognition of the identification code. Once the user code has been recognised, the vehicle control system gives the command to open the doors and enables start-up of the vehicle.

The solutions of this type are relatively laborious and costly to implement in practice. As illustrated above, they normally entail the installation of a dedicated electronic device on board each vehicle.

Furthermore, the above solutions often comprise the provision of a specific server network for management of the identification codes to be sent to the users.

The patent document U.S. Pat. No. 9,442,888B1 describes a user identification system which comprises the installation of an RFID reader on board each mixed-use vehicle. The RFID reader is able to read a user identification code from a card or other RFID support and transmit the user identification code to the vehicle control system. Here again, once the identification code has been recognised, the vehicle control system enables start-up of the vehicle.

Also the solutions of this type, although simpler than those previously described, entail the installation of fixed user identification devices on board every mixed-use vehicle. This obviously results in increased overall running costs of the vehicle fleet.

The patent document U.S. Pat. No. 10,068,402B2 describes an upgrade kit designed to be coupled with the vehicle key to modify the functions thereof and make it suitable for managing mixed use of the vehicle. The above-mentioned upgrade kit is designed to provide the key with an RFID reader having substantially the same functions as an RFID reader mounted on board the vehicle.

The solutions of this type are relatively complex to implement in practice. In general, in fact, the upgrade kit described above is difficult to manage, particularly in terms of the modes of sharing between several users and the relative modes of enablement for use.

In the light of the problems described above, in the state of the art there is a great need for new solutions that allow simple and inexpensive management of identification of a user accessing a vehicle intended for mixed use, for example a vehicle intended for use in care hire or car sharing services, company fleets, and the like.

The present invention aims to respond to said need by providing a key for a vehicle, according to claim 1 and the relative dependent claims listed below.

In a general definition, the key for a vehicle, according to the invention, comprises a control unit and a first wireless communication module operatively connected to said control unit and adapted to allow said control unit to communicate with a vehicle control system.

Preferably, said first communication module is a communication module for radiofrequency communications.

The key, according to the invention, comprises user interface means operatively connected to said control unit and which can be operated manually by a user.

Said user interface means are configured to allow a user to interact with the vehicle control system, by means of said control unit.

Advantageously, the above-mentioned user interface means can be operated manually to transmit command signals to the control unit of the key. Said control unit is configured to communicate with the vehicle control system in order to perform one or more predefined functions, in response to the reception of said command signals.

The key, according to the invention, is characterised in that the above-mentioned user interface means can be operated manually also to transmit a user identification code to the above-mentioned control unit of the key.

The control unit of the key is configured to transmit the identification code received from the user interface means to the vehicle control system, by means of the above-mentioned first wireless communication module.

According to some embodiments of the invention, the control unit of the key is configured to perform a preliminary validation of the identification code received from the above-mentioned user interface means, before transmitting the identification code to the vehicle control system.

In this case, transmission of the identification code to the vehicle control system, by the control unit, occurs only if the above-mentioned code is validated at local level by the control unit.

According to other embodiments of the invention, the control unit does not perform any control of the identification code entered by the user, which is validated only at the level of the vehicle control system.

The vehicle control system is advantageously configured to enable start-up of the vehicle and, if necessary, other functions of the vehicle, once the user identification code has been recognised.

According to a possible embodiment variation, the above-mentioned user interface means comprise one or more alphanumeric keys that can be manually operated to transmit a user identification code of the key to the control unit of the key.

According to another embodiment variation, the above-mentioned user interface means comprise one or more command buttons of the key. Said command buttons are normally adapted to allow a user to send command signals to the control unit of the key. However, according to said embodiment of the invention, said command buttons can be configured so that they can be manually operated to transmit a user identification code to the control unit of the key.

Preferably, the key according to the invention comprises a second wireless communication module operatively connected to the control unit of the key and adapted to allow the control unit of the key to communicate with the vehicle control system, also in the absence of power supply to the internal components of the key.

Preferably, the second communication module of the key comprises a passive electronic circuit for wireless communications in radio frequency.

Preferably, the key according to the invention comprises a third wireless communication module operatively connected to the control unit of the key and adapted to allow said control unit to communicate with a mobile computerised device.

Preferably, the third wireless communication module of the key comprises an electronic circuit for wireless communications at local level, for example for Bluetooth™ communications. According to one aspect of the invention, the control unit of the key is configured to communicate with the vehicle control system in order to cause the closure of one or more predefined doors of the vehicle, in response to a command signal received from the mobile computerised device, by means of the third wireless communication module of the key.

According to another aspect of the invention, the control unit of the key is configured to communicate with the vehicle control system in order to cause the opening of one or more predefined doors of the vehicle, in response to a command signal received from the mobile computerised device, by means of the above-mentioned third wireless communication module of the key.

According to another aspect of the invention, the control unit of the key is configured to communicate with the vehicle control system in order to disable one or more command buttons of the key, in response to a command signal received from the mobile computerised device, by means of the above-mentioned third wireless communication module of the key.

The key for a vehicle according to the invention provides a simple versatile solution to identify a user of a mixed-use vehicle.

The key for a vehicle, according to the invention, allows the user to communicate directly his/her identification code to the vehicle control system.

Unlike the solutions of the known art, the solution proposed by the present invention does not entail the installation of electronic devices dedicated to user identification on board the vehicle nor the use of dedicated electronic devices (for example a remote control) for sending an identification code to the vehicle control system.

The key according to the invention is particularly suitable for use in vehicles intended for mixed use, for example vehicles intended for care hire and car sharing services, company fleets, and the like.

However, it could be advantageously used also by private individuals in order to improve the safety of use of a vehicle. For example, it could be used by a family to prevent a child from using a vehicle even if he/she is in possession of the key.

Further characteristics and advantages of the present invention will become clear by referring to the description below and the attached figures, provided for purely illustrative non-limiting purposes, in which:

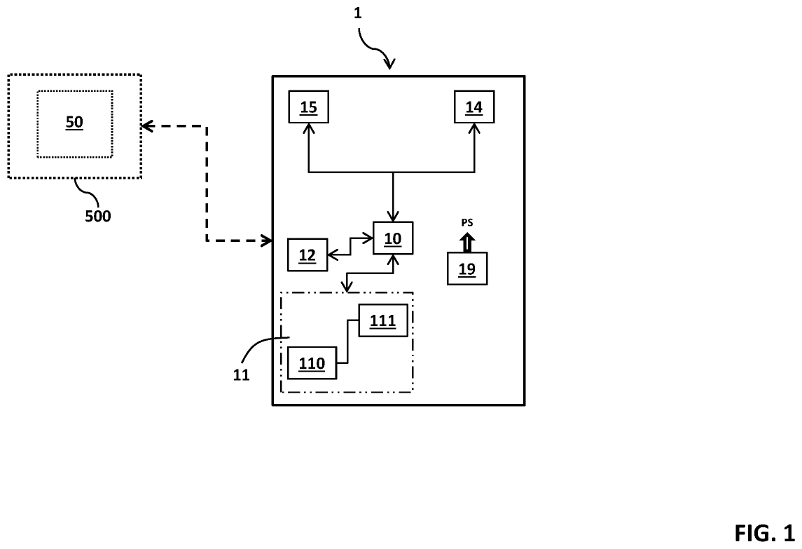

FIG. 1 illustrates schematically the key, according to the invention, in an embodiment thereof;

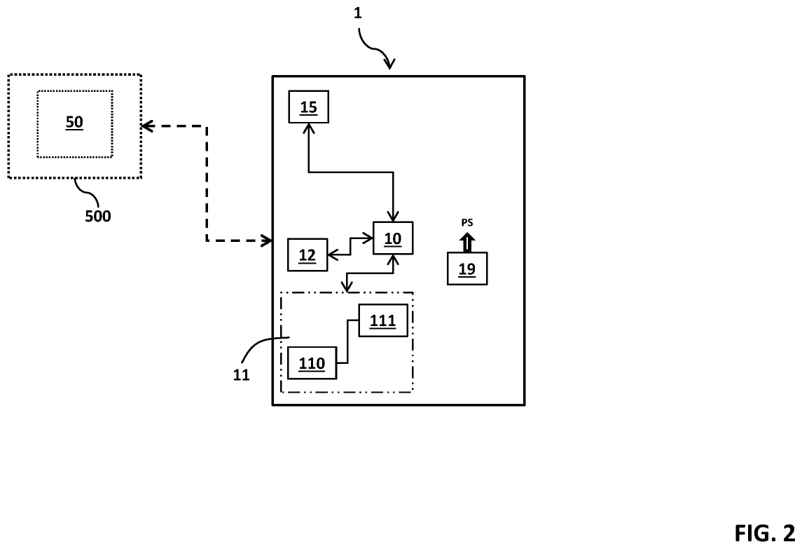

FIG. 2 illustrates schematically the key, according to the invention, in an alternative embodiment thereof;

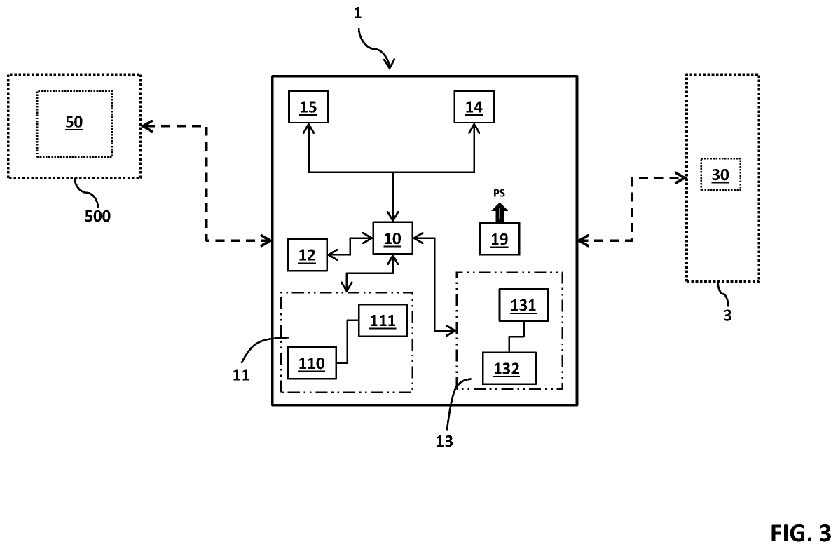

FIG. 3 illustrates schematically the key, according to the invention, in an alternative embodiment thereof;

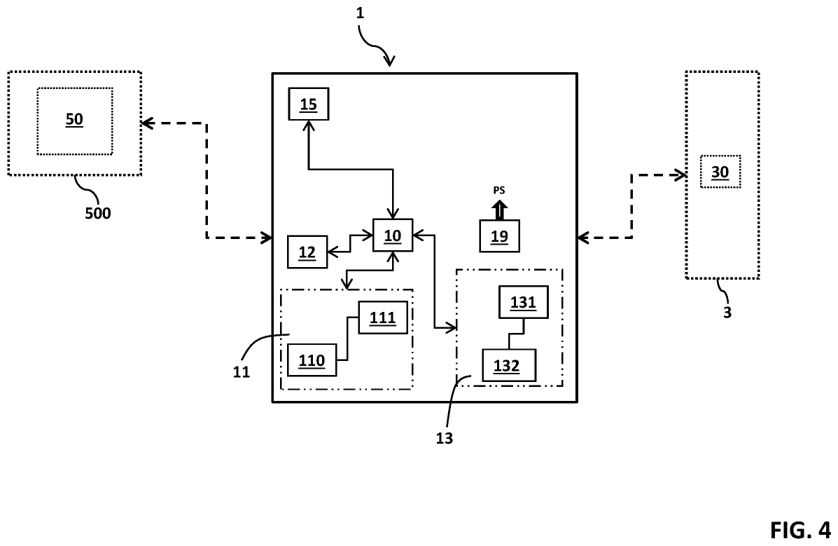

FIG. 4 illustrates schematically the key, according to the invention, in an alternative embodiment thereof.

With reference to the cited figure, the present invention refers to a key 1 for a vehicle 500, preferably a vehicle for mixed use.

The vehicle 500 comprises a control system 50 able to control the functions thereof. Said control system comprises for example an ECU (Engine Control Unit) and other appropriate control modules interacting with the latter.

In general, the vehicle 500 can be of known type. Therefore, it will be described below only in the aspects of importance for the invention, for evident reasons of brevity.

Preferably, the vehicle 500 is a motor vehicle provided with passenger compartment, for example an automobile.

The invention could also be advantageously applied in different types of vehicles, for example open motor vehicles (motorcycles, sidecars, and the like) provided with closable storage or luggage compartment.

In general, the key 1 according to the invention is a smart key, namely a key designed to communicate in wireless mode with the control system 50 of the vehicle 500. For example, the key 1 can be of the type with toothed blade to be inserted in a lock to start the vehicle or open the doors, or of the remote control type.

According to the invention, the key 1 comprises a control unit 10 comprising preferably at least one digital processing device, for example a microprocessor able to execute appropriate software instructions stored on a memory support to run the scheduled key functions.

Preferably, the key 1 comprises a first wireless communication module 11 operatively connected to the control unit 10 and designed to allow the control unit 10 to communicate with the vehicle control system 50.

Preferably, the communication module 11 comprises an electronic circuit for wireless communications in radiofrequency.

Preferably, said electronic circuit comprises a radio antenna 110 operatively connected to a transceiver 111 (for example operating in UHF band at 315, 433 or 868 MHz) operatively connected to the control unit 10.

According to some embodiment variations of the invention, the communication module 11 can be at least partially integrated in the control unit 10.

In general, the communication module 11 can be of known type and will not be described here in further detail for evident reasons of brevity.

The same communication between the control unit 10 of the key 1 and the control system 50 of the vehicle 500 (by means of the communication module 11) can be effected according to procedures of known type, widely used for the control of motor vehicles. Again, these modes of interaction will not be described here in detail for reasons of brevity.

Preferably, the key 1 comprises a battery and an electronic power supply circuit 19 designed to provide a PS (Power Supply) for some electronic components of the key, for example the control unit 10 and the communication modules operatively associated with it.

In general, also these components of the key 1 can be of known type and will not be described here in detail for evident reasons of brevity.

Preferably, the key 1 comprises a second wireless communication module 12 electrically connected to the control unit 10.

Preferably, the communication module 12 comprises a passive electronic circuit (RFID antenna) for wireless communications in radiofrequency (for example 124-134 kHz).

The communication module 12 is advantageously designed to allow the control unit 10 to communicate with the vehicle control system 50 also in the absence of a power supply for the internal components of the key.

In the absence of power supply, the communication module 12 allows some basic functions to be implemented for control of the vehicle, for example the immobilizer function.

According to the invention, the key 1 comprises user interface means 14, 15 operatively connected to the control unit 10 and which can be manually operated by a user. In general, said user interface means are configured to allow a user to interact with the vehicle control system 50, via the control unit 10 of the key.

Advantageously, the user interface means 14, 15 are configured to transmit command signals to the control unit 10. The latter is configured to communicate with the vehicle control system 50 in order to carry out one or more predefined functions, in response to reception of the above-mentioned command signals.

According to some embodiments of the invention, the above-mentioned user interface means comprise one or more command buttons 15 operatively connected to the control unit 10.

The command buttons 15 are configured to allow a user to send command signals to the control unit 10, for example a door opening command, a boot opening command, and so on.

In response to manual operation by a user, the command buttons 15 send appropriate command signals to the control unit 10. In response to said command signals, the control unit 10 interacts with the vehicle control system 50 to carry out some predefined functions, for example opening the doors or the boot.

Advantageously, the functions of the command buttons 15 can be configured during programming (firmware) of the control unit 10.

According to the invention, the interface means 14, 15 are configured also to transmit a user identification code (for example an alphanumeric code) to the control unit 10 of the key. The control unit 10 is advantageously configured to transmit the identification code received from the user interface means to the control system 50 of the vehicle 500, by means of the communication module 11.

According to some embodiments of the invention, the control unit 10 is configured to carry out a preliminary validation of the identification code received from the user interface means 14, 15 before transmitting the above-mentioned identification code to the vehicle control system 50.

In this case, the control unit 10 of the key transmits the identification code to the vehicle control system 50, only if the above-mentioned code is validated at local level by the control unit.

According to other embodiments of the invention, the control unit 10 does not carry out any control of the identification code entered by the user, which is validated only at the level of the vehicle control system 50.

The vehicle control system 50 is configured to perform a validation of the user identification code received from the control unit 10 of the key.

Once the identification code has been received and recognised, the vehicle control system 50 enables start-up of the vehicle. If necessary, the control system 50 can also enable other vehicle functions, for example opening of the vehicle doors, in response to the reception of a correct user identification code.

According to some embodiments of the invention (FIGS. 1 and 3), the above-mentioned user interface means comprise one or more alphanumeric keys 14 that can be operated manually to transmit a user identification code to the control unit 10 of the key.

According to some embodiments of the invention (FIGS. 2 and 4), the above-mentioned user interface means comprise one or more of the key command buttons 15 that can be operated manually to transmit a user identification code to the control unit 10 of the key.

Said key buttons are normally configured to allow a user to send command signals to the control unit 10, as illustrated above. However, they can be configured so that they can be manually operated to transmit a user identification code to the control unit 10.

For example, some command buttons 15 can be pressed simultaneously to switch to a transmission configuration, in which the key command buttons 15 can be manually operated to transmit a user identification code to the control unit 10.

Once transmission of the user identification code has been completed, the above-mentioned predefined command buttons can be pressed again simultaneously to return the key command buttons 15 to a normal operating configuration, in which they can be manually operated to send command signals to the control unit 10, as illustrated above.

According to some embodiments of the invention (FIGS. 3 and 4), the key 1 comprises a third wireless communication module 13 operatively connected to the control unit 10.

The communication module 13 is advantageously designed to allow the control unit 10 to communicate in wireless mode (at local level) with a mobile computerised device (not belonging to the vehicle 500), for example a smartphone, a tablet, a laptop computer, and the like.

Preferably the communication module 13 comprises an antenna for communications at local level 131 and a local controller 132 (for example a microprocessor) operatively connected to the antenna 131 and to the control unit 10 of the key.

Preferably, the communication module 13 comprises an electronic circuit able to implement communication protocols at local level, namely proximity communications, such as, for example, Wi-Fi™ or Bluetooth™ communication protocols, and the like.

In general, the communication module 13 can be of known type and will not be described here in further detail for reasons of brevity.

Also the interaction between the control unit 10 of the key 1 and the mobile computerised device 3 can take place according to modes of known type, widely used in proximity communications between electronic devices. Said interaction modes will not be described here in detail for reasons of brevity.

In general, the mobile computerised device 3 can be of any type, for example a smartphone, a tablet and the like.

The computerised device 3 advantageously comprises one or more communication ports for wireless communications at local level, for example Wi-Fi™ or Bluetooth™ communication ports, and the like.

Preferably, the mobile computerised device 3 is provided with a software application 30.

The mobile computerised device 3 is adapted to execute the software application 30 to send appropriate command signals to the control unit 10 of the key 1.

In response to said command signals, the control unit 10 interacts with the control system 50 of the vehicle 500 to carry out some predefined functions.

Preferably, according to the embodiments of the invention, illustrated in FIGS. 3-4, the control unit 10 is configured to communicate with the vehicle control system 50 to cause the opening of one or more predefined doors of the vehicle, in response to a command signal received from the mobile computerised device 3, by means of the wireless communication module 13.

This function further facilitates the management of a vehicle shared between several users. For example, the key 1 can be left inside the closed vehicle. To access the vehicle, the user can advantageously use his/her smartphone to communicate with the key and cause the opening of one or more doors.

Said function can also be widely applied in private or domestic settings. For example, a user who does not wish to take the key with him/her can leave it inside the passenger compartment. To access the vehicle again, the user can command opening of the vehicle doors via smartphone. Preferably, according to the embodiments of the invention illustrated in FIGS. 3-4, the control unit 10 is configured to communicate with the vehicle control system 50 to cause the closing of one or more predefined doors of the vehicle, in response to a command signal received from the mobile computerised device 3, by means of the wireless communication module 13.

This function is applied in situations in which it is desirable to allow the user to close the vehicle without using the key, for example leaving the key on board. It is particularly useful when the doors are provided with a motorised device for closure.

Preferably, according to the embodiments of the invention illustrated in FIGS. 3-4, the control unit 10 is configured to communicate with the vehicle control system 50 to prevent the opening of one or more predefined doors of the vehicle, in response to a command signal received from the mobile computerised device 3, by means of the wireless communication module 13.

This function is applied in situations in which it is desirable to allow the user to access only some areas of the vehicle. For example, a user can command via smartphone the opening only of some doors to allow him/her to access only the passenger compartment without being able to access the boot, or vice versa.

Preferably, according to the embodiments of the invention illustrated in FIGS. 3-4, the control unit 10 is configured to at least partially disable the above-mentioned user interface means (for example one or more of the command buttons 15) of the key, in response to a command signal received from the mobile computerised device 3, by means of the wireless communication module 13.

Thanks to said function, a user can be enabled to use only some command buttons of the key 1.

In practice it has been seen that the present invention offers numerous advantages with respect to the solutions of the known art currently available.

One important characteristics of the key, according to the invention, consists in the fact of allowing a user to communicate directly, in wireless mode, his/her identification code to the vehicle control system.

In this, the key for a vehicle according to the invention clearly differs from the solutions of the known art currently available.

The latter, in fact, entail the use of dedicated electronic devices that can be installed on board the vehicle or coupled to the key to transmit a user identification code to the vehicle control system.

According to the invention, the above-mentioned identification code and the command signals for the vehicle are entered by the user using the same user interface means 14, 15 as the key.

This avoids the use of dedicated electronic devices for entry of the identification code.

Furthermore, said solution allows a key to be obtained with a particularly compact structure.

Thanks to its simple structure and ease of use, the key for a vehicle according to the invention is widely used also in commercial and industrial settings. In fact, it is particularly suitable for use in vehicles intended for mixed use, for example vehicles intended for use in car hire or car sharing services, company fleets, and the like.

The key for a vehicle according to the invention, can also be used in private or domestic settings, in particular in order to improve the safety of use of a vehicle.

The key for a vehicle according to the invention is relatively simple and inexpensive to produce in practice. It can be produced industrially by using techniques for the production of electronic circuits of known type.

1-14. (canceled)

15. A key for a vehicle, comprising:
a control unit;
a first wireless communication module operatively connected to the control unit and configured to enable communications between the control unit and a vehicle control system; and
a user interface operatively connected to the control unit;
wherein the control unit is configured, responsive to manual user input received via the user interface and corresponding to an identification code of the user, to transmit the identification code to the vehicle control system via the first wireless communication module.

16. The key of claim 15, wherein the control unit is configured to carry out a preliminary validation of the identification code received from the user interface before transmitting the identification code to the vehicle control system.

17. The key of claim 15, wherein the user interface comprises one or more alphanumeric keys configured to transmit the user identification code to the control unit.

18. The key of claim 15, wherein the user interface comprises one or more command buttons configured to be manually operated to transmit the user identification code to the control unit.

19. The key of claim 15, wherein the user interface is configured to be manually operated to transmit command signals to the control unit, the control unit configured, responsive to the command signals, to communicate with the vehicle control system to perform one or more predefined functions.

20. The key of claim 15, wherein the first wireless communication module comprises an electronic circuit for wireless communications in radiofrequency.

21. The key of claim 15, comprising a second wireless communication module operatively connected to the control unit and configured to enable the control unit to communicate with the vehicle control system also in absence of a power supply for internal components of the key.

22. The key of claim 21, wherein the second wireless communication module comprises a passive electronic circuit for wireless communications in radiofrequency.

23. The key of claim 15, comprising a third wireless communication module operatively connected to the control unit and configured to enable the control unit to communicate with a mobile computerised device.

24. The key of claim 23, wherein the control unit is configured to communicate with the vehicle control system to cause opening of one or more predefined doors of the vehicle, responsive to a command signal received from the mobile computerised device via the third wireless communication module.

25. The key of claim 23, wherein the control unit is configured to communicate with the vehicle control system to cause closing of one or more predefined doors of the vehicle, responsive to a command signal received from the mobile computerised device via the third wireless communication module.

26. The key of claim 23, wherein the control unit is configured to communicate with the vehicle control system to prevent opening of one or more predefined doors of the vehicle, responsive to a command signal received from the mobile computerised device via the third wireless communication module.

27. The key of claim 23, wherein the control unit is configured to at least partially disable the user interface, responsive to a command signal received from the mobile computerised device via the third wireless communication module.

28. The key of claim 23, wherein the third wireless communication module comprises an electronic circuit for wireless communications at local level.

29. A method for managing identification of a user accessing a vehicle, using a key comprising a control unit, a user interface, and one or more wireless communication modules, the method comprising:
upon receiving, at the control unit, manual user input via the user interface and corresponding to an identification code of the user, transmitting the identification code to a control system of the vehicle via the one or more wireless communication modules.

30. The method of claim 29, comprising a preliminary validation of the identification code received from the user interface before transmitting the identification code to the control system of the vehicle.

31. The method of claim 29, further comprising:
upon receiving, at the control unit, manual user input via the user interface and corresponding to command signals, communicating with the control system of the vehicle to perform one or more predefined functions.

32. The method of claim 29, further comprising:
upon receiving, at the control unit, a respective command signal from a mobile computerized device via the one or more wireless communication modules, communicating with the control system of the vehicle to cause opening and/or closing of one or more predefined doors of the vehicle.

33. The method of claim 32, further comprising:
upon receiving, at the control unit, a respective command signal from a mobile computerized device via the one or more wireless communication modules, communicating with the control system of the vehicle to prevent opening of one or more predefined doors of the vehicle.

34. The method of claim 32, further comprising:
upon receiving, at the control unit, a respective command signal from a mobile computerized device via the one or more wireless communication modules, at least partially disabling the user interface.
